(19) United States
(12) Patent Application Publication
(10) Pub. No.: US 2009/0128687 A1
(43) Pub. Date: May 21, 2009

(54) License Plate Frame with Camera

(76) Inventor: Sung M. Woo, Buena Park, CA (US)

Correspondence Address: SHELDON MAK ROSE & ANDERSON PC, 100 Corson Street, Third Floor, PASADENA, CA, 91103-3842, US

(21) Appl. No.: 11/944,238

(22) Filed: Nov. 21, 2007

(51) Int. Cl. H04N 5/225

(52) U.S. Cl. 348/373; 348/E05.001

(57) ABSTRACT

A license plate frame and camera combination comprises a license plate frame and a camera assembly, the camera assembly comprising a housing and a camera lens. A pair of brackets positioned on the rim supports the camera assembly for rotational movement to change the field of view of the camera. Fastening means releasably hold at least one of the brackets on the rim. The fastener means are removable only from an inward facing surface of the rim to prevent removal of the camera assembly, unless the assembly is disengaged from the vehicle. Biasing springs engage at least one of the brackets and the housing of the camera assembly for holding the camera assembly on the frame. The biasing means provides a biasing force that allows the camera assembly to be rotated to a selected position for image collection by the camera lens, and at the same time maintain the camera assembly in the selected position while the vehicle is driven.

### BACKGROUND

License plate frames with built-in cameras for rearward viewing for safety are known. See, for example, U.S. Pat. No. 7,195,405 which describes such a frame having a camera with a movable lens for changing the field of view of the camera.

A problem with the device shown in U.S. Pat. No, 7,195,405 is that it is necessary to undo fasteners to change the field of view of the camera, which can be a time consuming process and requires use of a fastener remover such as a screw driver.

Therefore, there is a need for a license plate frame having a camera where the field of view of the camera is easily adjusted.

### SUMMARY

The present invention satisfies this need. The present invention is for a license plate frame and camera combination assembly comprising a license plate frame having an outward facing surface facing away from the vehicle, and an opposed inward facing surface. Mounting means for mounting the frame on a vehicle are provided. The assembly includes a camera assembly comprising a housing and a camera lens, and a pair of brackets positioned on the outward facing surface of the rim. The brackets support the camera assembly for rotational movement to change the field of view of the camera. Fastening means are provided for releasably fastening at least one of the brackets to the rim. The fastening means are removable only from the inward facing surface of the rim to prevent removal of the camera assembly, unless the assembly is disengaged from the vehicle.

Biasing means such as springs engage at least one of the brackets and the housing of the camera assembly for holding the camera assembly on the frame. The biasing means provides a biasing force that allows the camera assembly to be rotated to a selected position for image collection by the camera lens, and at the same time maintain the camera assembly in the selected position while the vehicle is driven.

Thus, like the combination shown in the '405 patent, the present invention helps avoid vandalism and theft of the camera assembly because it is necessary to remove the license plate frame at least partially from the vehicle to access the camera housing. However, due to the use of biasing means for mounting the camera housing in the brackets, the field of the view of the camera assembly is easily adjustable.

Preferably the housing is dodecahedron in cross section to provide multiple gripping surfaces for easy rotational movement of the camera assembly.

### DRAWINGS

These and other features, aspects and advantages of the present invention become better understood with regard to the following desorption, appended claims, and accompanying drawings where:

FIG. 1 is an exploded perspective view of a license plate frame and camera assembly having features of the present invention;

FIG. 2 is a perspective view of the assembly of FIG. 1 assembled;

FIG. 3 is a sectional view of the assembly of FIG. 1 taken on line 3-3 in FIG. 2;

FIG. 4 is an exploded front elevation view of the assembly of FIG. 1; and

FIG. 5 is another sectional view of the assembly of FIG. 1 taken on line 5-5 in FIG. 4.

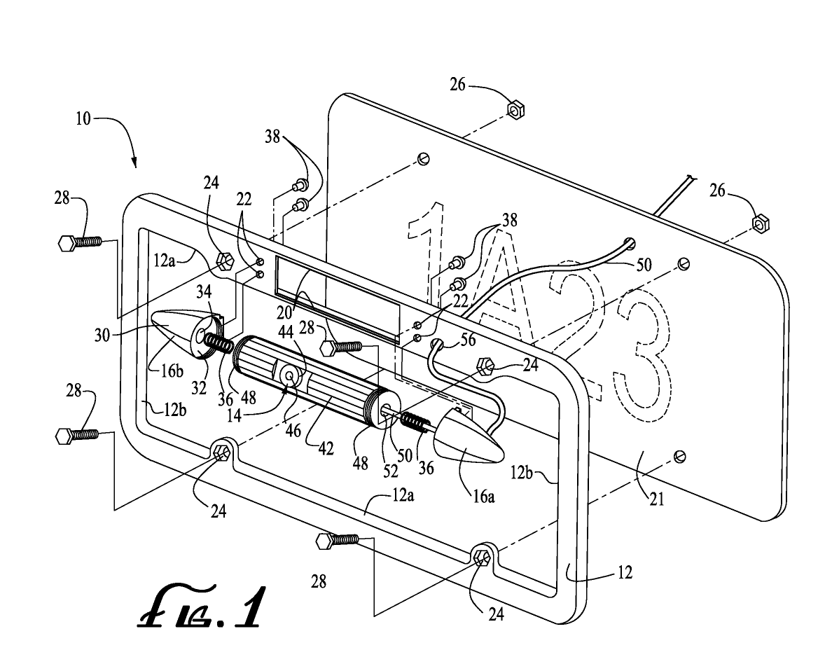

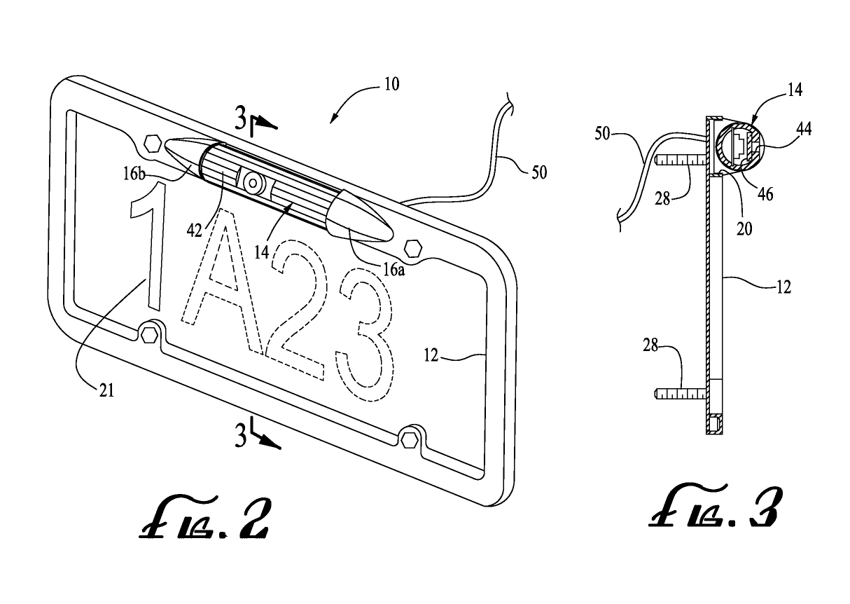

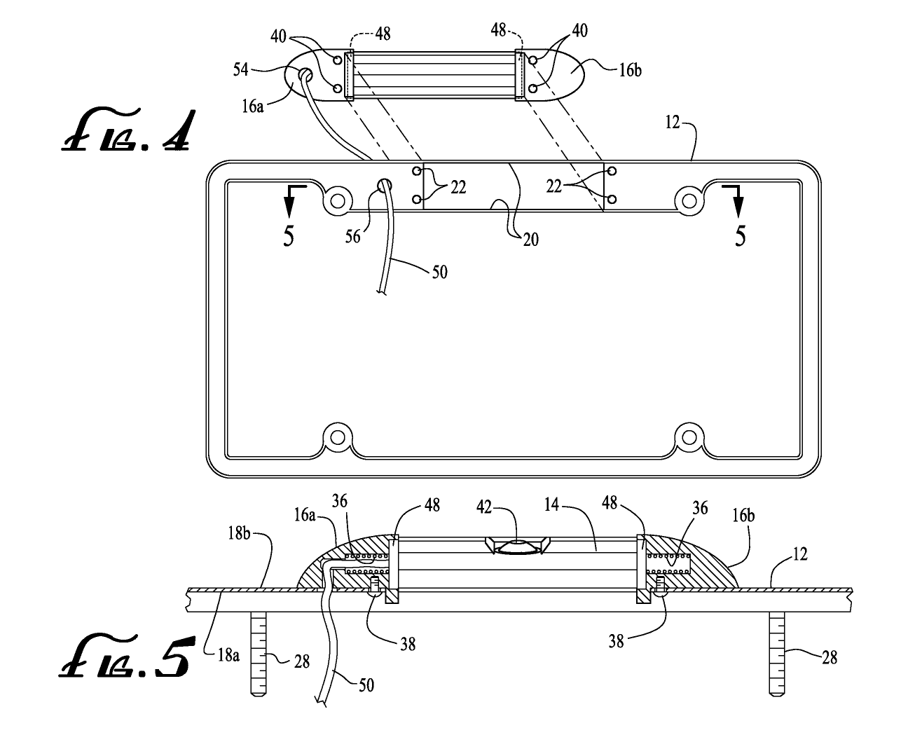

### DESCRIPTION

A license plate frame and camera combination 10, also referred to as an assembly, comprises a license plate frame 12, a camera housing 14, and brackets 16a and 16b for supporting the camera assembly 14 on the license plate frame 12.

The license plate frame 12 is generally rectangular, has opposed surfaces, an inwardly facing surface 18a and an outwardly facing surface 18b. The directions “inward” and “outward” refer to when the frame is mounted on a vehicle. Thus, the inwardly facing surface faces the vehicle and the outwardly facing surface 18b faces behind the vehicle. The license plate frame 12 is formed of opposed longer segments 12a and opposed shorter segments 12b with an opening between the segments so a license plate 21 is visible. The frame 12 contains an elongated opening 20 for placement of the camera housing 14. There are also four fastener openings 22, two for each bracket 16, adjacent the camera assembly opening 20. There are also four fastener openings 24 for attaching the assembly to a vehicle, using a fastener means suitable for this purpose, such as a nut 26 and bolt 28. Other means including screws, Velcro™ hook and loop fasteners, and adhesives. The camera assembly opening 20 and bracket fastener openings 22 are all in the same longer frame segment 12a.

Each bracket 16 has a closed end 30 and an open end 32, the two open ends 32 facing each other. Inside each bracket 16 is a generally elongated cylindrically shaped spring holder 34 for holding biasing springs 36. The brackets 16 are secured to the license plate frame by fasteners means such as screws 38. The screws are threaded through the openings 24 from the inward surface 18a into correspondingly threaded openings 40 in the brackets 16. Thus, only by removing the assembly 10 from a vehicle can the screws 38 be accessed for removing the bracket 16 from the frame 12 to have access to the camera assembly 14. Other fastening means can be used, such as nuts and bolts.

Although the invention is shown with both brackets being removable from the frame 12, one of the brackets can be permanently attached to the frame, or can be made integral with the frame 12, and thus be part of a single assembly and not removable.

The camera assembly 14 comprises a housing 42 with a camera (not shown) therein, and an opening 44 on an external wall for a camera lens 46. The housing is elongated with a longitudinal axis and has opposed end surfaces 48.

Biasing means such as the biasing springs 36 extend into the spring holder 34 and press against the camera housing end surfaces 48, thereby holding the camera assembly 14 in the camera assembly opening 20 of the frame. The housing of the camera assembly 14 can be rotated around the housing's longitudinal axis for placing the camera lens 46 in a position to obtain a desired field of view. The biasing springs 36 can be secured in position on either the bracket or the housing such as by an adhesive or a mounting projection with a retention groove therein.

The biasing springs provide a biasing force that allows the camera assembly 14 to be rotated to a selected position for image collection by the lens and for maintaining the camera assembly in the selected position while the vehicle is driven. For example, a pair of identical biasing springs can provide a force of about 50 kg, when compressed by ¼ inch. Such a spring can have an outer diameter of about 21 mm, there being about 32 coils per linear inch.

Biasing means other than springs can be used, such as resilient foam or other resilient polymeric materials.

Preferably the camera assembly housing 42 has an easily grippable outer surface for adjusting the position of the lens. For example, the version of the invention shown in the figures has a housing that in vertical cross-section is a dodecahedron, thereby providing twelve gripping surfaces.

The assembly can be made out of conventional materials, such as metal, including steel and aluminum, or a rigid plastic.

An image from the camera is transmitted by a cable 50 which extends out through a cable opening 52 in one of the end surfaces 48 of the housing 42 through the middle of the corresponding spring 36 into the bracket 16a through an opening 54 in the back surface of the bracket 16a, through a hole 56 in the frame, and then leading to a vision device such as a monitor (not shown).

Although the present invention has been described in considerable detail with reference to certain preferred version thereof, other versions are possible. For example, the test tube or container can be stationary while the light sources and the light detector move along the vertical axis of the tube or container. Also, in some instances the container can contain no cells and no gel, and thus the only interface detected is the one between plasma or serum and the air in the container. Therefore, the spirit and scope of the appended claims should not necessarily be limited to the description of the preferred versions contained herein.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” for “step” clause as specified in 35 U.S.C. §112.

1. A license plate frame and camera combination comprising:
a) a license plate frame having a generally rectangular peripheral rim with an outward facing surface for facing away from a vehicle and an opposed inward facing surface, the rim composed of opposed longer segments and opposed shorter segments with an opening therebetween for placement of a license plate;
b) means for mounting the frame on a vehicle with the outward facing surface of the frame facing away from the vehicle;
c) a camera assembly comprising an elongated housing with a camera lens at an outer surface thereof, the housing having a longitudinal axis and end surfaces, the outer surface of the housing being a dodecahedron in cross section;
d) a pair of brackets positioned on the outward facing surface of one of the longer segments of the rim, the brackets supporting the camera assembly for rotational movement around its longitudinal axis;
e) fastening means for releasably fastening the brackets in position on the rim, the fastening means being removable only from the inward facing surface of the rim for preventing removal of the camera assembly without disengaging the assembly from the vehicle; and
f) a pair of biasing springs, each engaging one of the brackets and one of the end surfaces of the camera assembly for holding the camera assembly on the frame with a biasing force that allows the camera assembly to be rotated to a selected position for image collection by the lens and for maintaining the camera assembly in the selected position while the vehicle is driven.

2. A license plate frame and camera combination comprising:
a) a license plate frame having an outward facing surface for facing away from a vehicle and an opposed inward facing surface;
b) means for mounting the frame on a vehicle with the outward facing surface of the frame facing away from the vehicle;
c) a camera assembly comprising a housing and a camera lens;
d) a pair of brackets positioned on the outward facing surface of the rim, the brackets supporting the camera assembly for rotational movement;
e) fastening means for releasably fastening at least one of the brackets on the rim, the fastening means being removable only from the inward facing surface of the rim for preventing removal of the camera assembly without disengaging the license plate frame from the vehicle; and
f) biasing means engaging at least one of the brackets and the housing of the camera assembly for holding the camera assembly on the frame with a biasing force that allows the camera assembly to be rotated to a selected position for image collection by the lens and for maintaining the camera assembly in the selected position while the vehicle is driven.

3. The combination of claim 2 wherein both brackets are releasably held on the rim.

4. The combination of claim 1 wherein the housing has an outer surface which is a dodecahedron in cross section.

5. The combination of claim 1 wherein the mounting means comprises openings in the peripheral rim and fasteners extending through the openings to support a vehicle.

6. The combination of claim 1 mounted on a vehicle.

7. A method of adapting a vehicle for rearward vision comprising the steps of:
(a) selecting the license plate frame and camera combination of claim 2;
(b) mounting the combination on the rear of the vehicle; and
(c) rotating the camera assembly so that the camera lens provides the desired field of view without releasing any fasteners.
